(19) United States
(12) Patent Application Publication
(10) Pub. No.: US 2014/0314246 A1
(43) Pub. Date: Oct. 23, 2014

(54) SYSTEMS AND METHODS FOR HYBRID ADAPTIVE NOISE CANCELLATION

(71) Applicant: Cirrus Logic, Inc., Austin, TX (US)

(72) Inventor: Ryan A. Hellman, Austin, TX (US)

(21) Appl. No.: 13/924,935

(22) Filed: Jun. 24, 2013

Related U.S. Application Data
(60) Provisional application No. 61/812,823, filed on Apr. 17, 2013.

(51) Int. Cl. G10K 11/16

(52) U.S. Cl. CPC G10K 11/16
USPC 381/71.11

(57) ABSTRACT

In accordance with systems and methods of this disclosure, a method may include generating a feedforward anti-noise signal component from a result of measuring with the reference microphone countering the effects of ambient audio sounds at an acoustic output of a transducer by filtering an output of the reference microphone, adaptively generating a feedback anti-noise signal component from a result of measuring with an error microphone for countering the effects of ambient audio sounds at the acoustic output of the transducer by adapting a response of a feedback adaptive filter that filters a synthesized reference feedback to minimize the ambient audio sounds in the error microphone signal, wherein the synthesized reference feedback is based on a difference between the error microphone signal and the feedback anti-noise signal component.

### RELATED APPLICATION

The present disclosure claims priority to U.S. Provisional Patent Application Ser. No. 61/812,823, filed Apr. 17, 2013, which is incorporated by reference herein in its entirety.

### FIELD OF DISCLOSURE

The present disclosure relates in general to adaptive noise cancellation in connection with an acoustic transducer, and more particularly, to detection and cancellation of ambient noise present in the vicinity of the acoustic transducer using both feedforward and feedback adaptive noise cancellation techniques.

### BACKGROUND

Wireless telephones, such as mobile/cellular telephones, cordless telephones, and other consumer audio devices, such as mp3 players, are in widespread use. Performance of such devices with respect to intelligibility can be improved by providing noise canceling using a microphone to measure ambient acoustic events and then using signal processing to insert an anti-noise signal into the output of the device to cancel the ambient acoustic events.

Because the acoustic environment around personal audio devices, such as wireless telephones, can change dramatically, depending on the sources of noise that are present and the position of the device itself, it is desirable to adapt the noise canceling to take into account such environmental changes. However, adaptive noise canceling circuits can be complex, consume additional power, and can generate undesirable results under certain circumstances. For example, as depicted in FIG. 1, some noise canceling circuits employ hybrid adaptive noise cancellation, including both: (i) an adaptive feedforward system 102 for generating a feedforward anti-noise signal component from a reference microphone signal ref provided by a reference microphone R and indicative of ambient audio sounds; and (ii) an adaptive feedback system 104 including an adaptive filter 110 and a coefficient control block 112 for generating coefficients for adaptive filter 110, wherein adaptive feedback system 104 generates a feedback anti-noise signal component from a synthesized reference feedback signal synref, the synthesized reference feedback signal based on a difference between an error microphone signal err and an anti-noise signal, wherein the anti-noise signal is equal to the sum of the feedforward anti-noise signal component and the feedback anti-noise signal component, and wherein error microphone signal err is provided by an error microphone E and is indicative of an acoustic output of a transducer 106 (e.g., loudspeaker) and the ambient audio sounds at transducer 106. Before being subtracted from error microphone signal err to generate synthesized reference feedback signal synref, the anti-noise signal is filtered by a secondary path estimate filter 108 for modeling an electro-acoustic path of a source audio signal through transducer 106.

In such approach, synthesized reference feedback signal synref synthesizes the ambient noise seen by error microphone E and is thus independent of the effect of adaptive feedforward system 102. The consequence is that adaptive feedback system 104 is unable to determine the frequency regions that feedforward system 102 has cancelled and adapts to reduce noise in the same regions, causing performance of the adaptive noise cancellation system to suffer.

### SUMMARY

In accordance with the teachings of the present disclosure, the disadvantages and problems associated with detection and reduction of ambient narrow band noise associated with an acoustic transducer may be reduced or eliminated.

In accordance with embodiments of the present disclosure, a personal audio device may include a personal audio device housing, a transducer mounted on the housing for reproducing an audio signal including both source audio for playback to a listener and an anti-noise signal for countering the effects of ambient audio sounds in an acoustic output of the transducer, a reference microphone mounted on the housing for providing a reference microphone signal indicative of the ambient audio sounds, an error microphone mounted on the housing in proximity to the transducer for providing an error microphone signal indicative of the acoustic output of the transducer and the ambient audio sounds at the transducer, and a processing circuit. The processing circuit may implement a feedforward filter having a response that generates a feedforward anti-noise signal component from the reference microphone signal. The processing circuit may also implement a feedback adaptive filter having a response that generates a feedback anti-noise signal component from a synthesized reference feedback, the synthesized reference feedback based on a difference between the error microphone signal and the feedback anti-noise signal component, and wherein the anti-noise signal comprises the feedforward anti-noise signal component and the feedback anti-noise signal component. The processing circuit may also implement a feedback coefficient control block that shapes the response of the feedback adaptive filter in conformity with the error microphone signal and the synthesized reference feedback by adapting the response of the feedback adaptive filter to minimize the ambient audio sounds in the error microphone signal.

In accordance with these and other embodiments of the present disclosure, a method for canceling ambient audio sounds in the proximity of a transducer of a personal audio device may include measuring ambient audio sounds with a reference microphone to produce a reference microphone signal, measuring an output of the transducer and the ambient audio sounds at the transducer with an error microphone, generating a feedforward anti-noise signal component from a result of the measuring with the reference microphone countering the effects of ambient audio sounds at an acoustic output of the transducer by filtering an output of the reference microphone, adaptively generating a feedback anti-noise signal component from a result of the measuring with the error microphone for countering the effects of ambient audio sounds at the acoustic output of the transducer by adapting a response of a feedback adaptive filter that filters a synthesized reference feedback to minimize the ambient audio sounds in the error microphone signal, wherein the synthesized reference feedback is based on a difference between the error microphone signal and the feedback anti-noise signal component; and combining the anti-noise signal with a source audio signal to generate an audio signal provided to the transducer.

In accordance with these and other embodiments of the present disclosure, an integrated circuit for implementing at least a portion of a personal audio device may include an output for providing a signal to a transducer including both source audio for playback to a listener and an anti-noise signal for countering the effect of ambient audio sounds in an acoustic output of the transducer, a reference microphone input for receiving a reference microphone signal indicative of the ambient audio sounds, an error microphone input for receiving an error microphone signal indicative of the output of the transducer and the ambient audio sounds at the transducer, and a processing circuit. The processing circuit may implement a feedforward filter having a response that generates a feedforward anti-noise signal component from the reference microphone signal. The processing circuit may also implement a feedback adaptive filter having a response that generates a feedback anti-noise signal component from a synthesized reference feedback, the synthesized reference feedback based on a difference between the error microphone signal and the feedback anti-noise signal component, and wherein the anti-noise signal comprises the feedforward anti-noise signal component and the feedback anti-noise signal component. The processing circuit may also implement a feedback coefficient control block that shapes the response of the feedback adaptive filter in conformity with the error microphone signal and the synthesized reference feedback by adapting the response of the feedback adaptive filter to minimize the ambient audio sounds in the error microphone signal.

Technical advantages of the present disclosure may be readily apparent to one of ordinary skill in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a block diagram depicting selected signal processing circuits and functional blocks within a hybrid active noise canceling (ANC) circuit including both feedforward and feedback, as is known in the art;

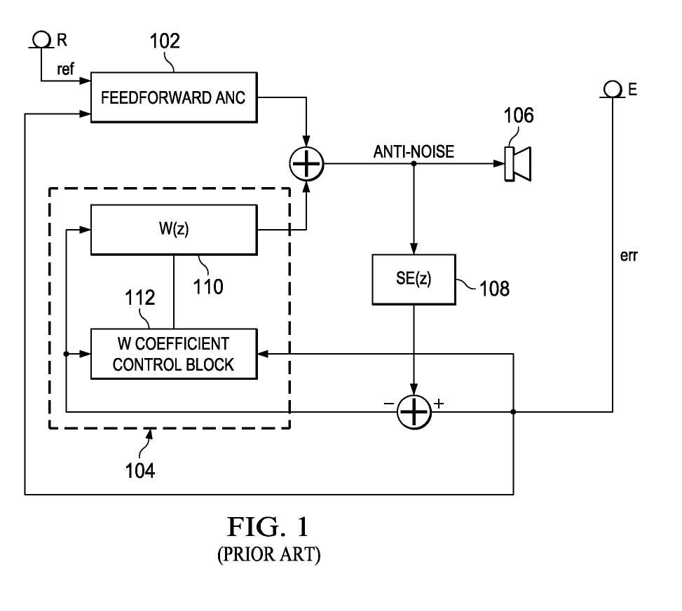

FIG. 2 is an illustration of a wireless mobile telephone, in accordance with embodiments of the present disclosure;

FIG. 3 is a block diagram of selected circuits within the wireless telephone depicted in FIG. 2, in accordance with embodiments of the present disclosure; and

FIG. 4 is a block diagram depicting selected signal processing circuits and functional blocks within an ANC circuit of a coder-decoder (CODEC) integrated circuit of FIG. 4, in accordance with embodiments of the present disclosure.

### DETAILED DESCRIPTION

The present disclosure encompasses noise canceling techniques and circuits that can be implemented in a personal audio device, such as a wireless telephone. The personal audio device includes an ANC circuit that may measure the ambient acoustic environment and generate a signal that is injected in the speaker (or other transducer) output to cancel ambient acoustic events. A reference microphone may be provided to measure the ambient acoustic environment and an error microphone may be included for controlling the adaptation of the anti-noise signal to cancel the ambient audio sounds and for correcting for the electro-acoustic path from the output of the processing circuit through the transducer.

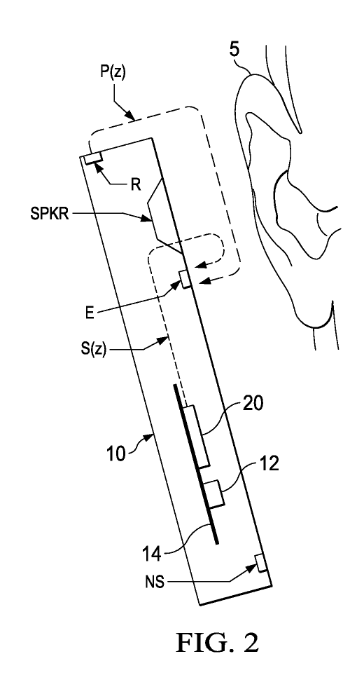

Referring now to FIG. 2, a wireless telephone 10 as illustrated in accordance with embodiments of the present disclosure is shown in proximity to a human ear 5. Wireless telephone 10 is an example of a device in which techniques in accordance with embodiments of the invention may be employed, but it is understood that not all of the elements or configurations embodied in illustrated wireless telephone 10, or in the circuits depicted in subsequent illustrations, are required in order to practice the invention recited in the claims. Wireless telephone 10 may include a transducer such as speaker SPKR that reproduces distant speech received by wireless telephone 10, along with other local audio events such as ringtones, stored audio program material, injection of near-end speech (i.e., the speech of the user of wireless telephone 10) to provide a balanced conversational perception, and other audio that requires reproduction by wireless telephone 10, such as sources from webpages or other network communications received by wireless telephone 10 and audio indications such as a low battery indication and other system event notifications. A near-speech microphone NS may be provided to capture near-end speech, which is transmitted from wireless telephone 10 to the other conversation participant(s).

Wireless telephone 10 may include ANC circuits and features that inject an anti-noise signal into speaker SPKR to improve intelligibility of the distant speech and other audio reproduced by speaker SPKR. A reference microphone R may be provided for measuring the ambient acoustic environment, and may be positioned away from the typical position of a user's mouth, so that the near-end speech may be minimized in the signal produced by reference microphone R. Another microphone, error microphone E, may be provided in order to further improve the ANC operation by providing a measure of the ambient audio combined with the audio reproduced by speaker SPKR close to ear 5, when wireless telephone 10 is in close proximity to ear 5. Circuit 14 within wireless telephone 10 may include an audio CODEC integrated circuit (IC) 20 that receives the signals from reference microphone R, near-speech microphone NS, and error microphone E and interfaces with other integrated circuits such as a radio-frequency (RF) integrated circuit 12 having a wireless telephone transceiver. In some embodiments of the disclosure, the circuits and techniques disclosed herein may be incorporated in a single integrated circuit that includes control circuits and other functionality for implementing the entirety of the personal audio device, such as an MP3 player-on-a-chip integrated circuit.

In general, ANC techniques of the present disclosure measure ambient acoustic events (as opposed to the output of speaker SPKR and/or the near-end speech) impinging on reference microphone R, and by also measuring the same ambient acoustic events impinging on error microphone E, ANC processing circuits of wireless telephone 10 adapt an anti-noise signal generated from the output of reference microphone R to have a characteristic that minimizes the amplitude of the ambient acoustic events at error microphone E. Because acoustic path P(z) extends from reference microphone R to error microphone E, ANC circuits are effectively estimating acoustic path P(z) while removing effects of an electro-acoustic path S(z) that represents the response of the audio output circuits of CODEC IC 20 and the acoustic/electric transfer function of speaker SPKR including the coupling between speaker SPKR and error microphone E in the particular acoustic environment, which may be affected by the proximity and structure of ear 5 and other physical objects and human head structures that may be in proximity to wireless telephone 10, when wireless telephone 10 is not firmly pressed to ear 5. While the illustrated wireless telephone 10 includes a two-microphone ANC system with a third near-speech microphone NS, some aspects of the present invention may be practiced in a system that does not include separate error and reference microphones, or a wireless telephone that uses near-speech microphone NS to perform the function of the reference microphone R. Also, in personal audio devices designed only for audio playback, near-speech microphone NS will generally not be included, and the near-speech signal paths in the circuits described in further detail below may be omitted, without changing the scope of the disclosure, other than to limit the options provided for input to the microphone covering detection schemes.

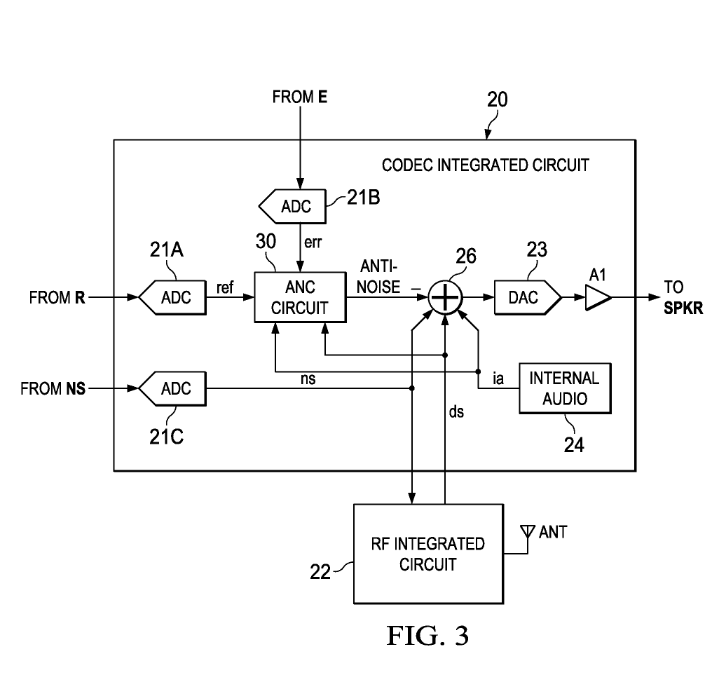

Referring now to FIG. 3, selected circuits within wireless telephone 10 are shown in a block diagram. CODEC IC 20 may include an analog-to-digital converter (ADC) 21A for receiving the reference microphone signal and generating a digital representation ref of the reference microphone signal, an ADC 21B for receiving the error microphone signal and generating a digital representation err of the error microphone signal, and an ADC 21C for receiving the near speech microphone signal and generating a digital representation ns of the near speech microphone signal. CODEC IC 20 may generate an output for driving speaker SPKR from an amplifier A1, which may amplify the output of a digital-to-analog converter (DAC) 23 that receives the output of a combiner 26. Combiner 26 may combine audio signals is from internal audio sources 24, the anti-noise signal generated by ANC circuit 30, which by convention has the same polarity as the noise in reference microphone signal ref and is therefore subtracted by combiner 26, and a portion of near speech microphone signal ns so that the user of wireless telephone 10 may hear his or her own voice in proper relation to downlink speech ds, which may be received from radio frequency (RF) integrated circuit 22 and may also be combined by combiner 26. Near speech microphone signal ns may also be provided to RF integrated circuit 22 and may be transmitted as uplink speech to the service provider via antenna ANT.

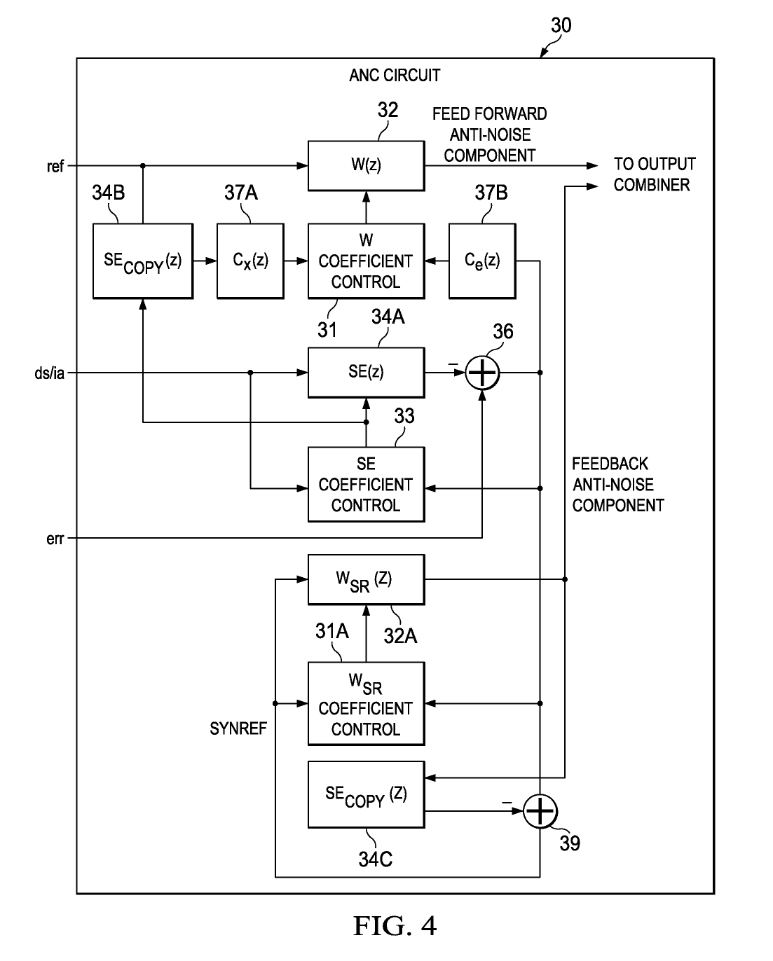

Referring now to FIG. 4, details of ANC circuit 30 are shown in accordance with embodiments of the present disclosure. Feedforward adaptive filter 32 may receive reference microphone signal ref and under ideal circumstances, may adapt its transfer function W(z) to be P(z)/S(z) to generate a feedforward anti-noise signal component, which may be provided to an output combiner that combines the feedforward anti-noise signal component and the feedback anti-noise signal component described below with the audio to be reproduced by the transducer, as exemplified by combiner 26 of FIG. 3. The coefficients of feedforward adaptive filter 32 may be controlled by a W coefficient control block 31 that uses a correlation of signals to determine the response of feedforward adaptive filter 32, which generally minimizes the error, in a least-mean squares sense, between those components of reference microphone signal ref present in error microphone signal err. The signals compared by W coefficient control block 31 may be the reference microphone signal ref as shaped by a copy of an estimate of the response of path S(z) provided by filter 34B and another signal that includes error microphone signal err (e.g., a playback corrected error equal error microphone signal err minus the downlink speech signal ds and/or internal audio signal ia as transformed by the estimate of the response of path S(z), response SE(z)). By transforming reference microphone signal ref with a copy of the estimate of the response of path S(z), response SE_{COPY}(z), and minimizing the difference between the resultant signal and error microphone signal err, feedforward adaptive filter 32 may adapt to the desired response of P(z)/S(z). In addition, a filter 37A that has a response Cₓ(z) as explained in further detail below, may process the output of filter 34B and provide the first input to W coefficient control block 31. The second input to W coefficient control block 31 may be processed by another filter 37B having a response of Cₑ(z). Response Cₑ(z) may have a phase response matched to response Cₓ(z) of filter 37A. Both filters 37A and 37B may include a highpass response, so that DC offset and very low frequency variation are prevented from affecting the coefficients of W(z). In addition to error microphone signal err, the signal compared to the output of filter 34B by W coefficient control block 31 may include an inverted amount of downlink audio signal ds and/or internal audio signal ia that has been processed by filter response SE(z), of which response SE_{COPY}(z) is a copy. By injecting an inverted amount of downlink audio signal ds and/or internal audio signal ia, feedforward adaptive filter 32 may be prevented from adapting to the relatively large amount of downlink audio and/or internal audio signal present in error microphone signal err and by transforming that inverted copy of downlink audio signal ds and/or internal audio signal ia with the estimate of the response of path S(z), the downlink audio and/or internal audio that is removed from error microphone signal err before comparison should match the expected version of downlink audio signal ds and/or internal audio signal ia reproduced at error microphone signal err, because the electrical and acoustical path S(z) is the path taken by downlink audio signal ds and/or internal audio signal ia to arrive at error microphone E. Filter 34B may not be an adaptive filter, per se, but may have an adjustable response that is tuned to match the response of adaptive filter 34A, so that the response of filter 34B tracks the adapting of adaptive filter 34A.

Feedback adaptive filter 32A may receive a synthesized reference feedback signal synref and under ideal circumstances, may adapt its transfer function W_{SR}(z) to be P(z)/S(z) to generate a feedback anti-noise signal component, which may be provided to an output combiner that combines the feedforward anti-noise signal component and the feedback anti-noise signal component with the audio to be reproduced by the transducer, as exemplified by combiner 26 of FIG. 3. Thus, the feedforward anti-noise signal component and feedback anti-noise signal component may combine to generate the anti-noise for the overall ANC system. Synthesized reference feedback signal synref may be generated by combiner 39 based on a difference between a signal that includes the error microphone signal (e.g., the playback corrected error) and the feedback anti-noise signal component as shaped by a copy SE_{COPY}(z) of an estimate of the response of path S(z) provided by filter 34C. The coefficients of feedback adaptive filter 32A may be controlled by a W_{SR} coefficient control block 31A that uses a correlation of signals to determine the response of feedback adaptive filter 32A, which generally minimizes the error, in a least-mean squares sense, between those components of synthesized reference feedback signal synref present in error microphone signal err. The signals compared by W_{SR} coefficient control block 31A may be the synthesized reference feedback signal synref and another signal that includes error microphone signal err. By minimizing the difference between the synthesized reference feedback signal synref and error microphone signal err, feedback adaptive filter 32A may adapt to the desired response of P(z)/S(z).

To implement the above, adaptive filter 34A may have coefficients controlled by SE coefficient control block 33, which may compare downlink audio signal ds and/or internal audio signal ia and error microphone signal err after removal of the above-described filtered downlink audio signal ds and/or internal audio signal ia, that has been filtered by adaptive filter 34A to represent the expected downlink audio delivered to error microphone E, and which is removed from the output of adaptive filter 34A by a combiner 36 to generate the playback corrected error. SE coefficient control block 33 correlates the actual downlink speech signal ds and/or internal audio signal ia with the components of downlink audio signal ds and/or internal audio signal ia that are present in error microphone signal err. Adaptive filter 34A may thereby be adapted to generate a signal from downlink audio signal ds and/or internal audio signal ia, that when subtracted from error microphone signal err, contains the content of error microphone signal err that is not due to downlink audio signal ds and/or internal audio signal ia.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

1. A personal audio device comprising:
a personal audio device housing;
a transducer coupled to the housing for reproducing an audio signal including both source audio for playback to a listener and an anti-noise signal for countering the effects of ambient audio sounds in an acoustic output of the transducer;
a reference microphone coupled to the housing for providing a reference microphone signal indicative of the ambient audio sounds;
an error microphone coupled to the housing in proximity to the transducer for providing an error microphone signal indicative of the acoustic output of the transducer and the ambient audio sounds at the transducer; and
a processing circuit that implements:
a feedforward filter having a response that generates a feedforward anti-noise signal component from the reference microphone signal;
a feedback adaptive filter having a response that generates a feedback anti-noise signal component from a synthesized reference feedback, the synthesized reference feedback based on a difference between the error microphone signal and the feedback anti-noise signal component, and wherein the anti-noise signal comprises the feedforward anti-noise signal component and the feedback anti-noise signal component; and
a feedback coefficient control block that shapes the response of the feedback adaptive filter in conformity with the error microphone signal and the synthesized reference feedback by adapting the response of the feedback adaptive filter minimize the ambient audio sounds in the error microphone signal.

2. The personal audio device of claim 1, wherein the feedforward filter is an adaptive filter and the processing circuit further implements a feedforward coefficient control block that shapes the response of the feedforward filter in conformity with the error microphone signal and the reference microphone signal by adapting the response of the feedforward filter to minimize the ambient audio sounds in the error microphone signal.

3. The personal audio device of claim 1, wherein the processing circuit further implements a secondary path estimate filter configured to model an electro-acoustic path of the source audio signal and have a response that generates the secondary path estimate from the source audio signal.

4. The personal audio device of claim 3, wherein the synthesized reference feedback is based on a difference between the error microphone signal and a signal generated by applying the response of the secondary path estimate filter to the feedback anti-noise signal component.

5. The personal audio device of claim 3, wherein the secondary path estimate filter is adaptive and the processing circuit further implements a secondary path estimate coefficient control block that shapes the response of the secondary path estimate filter in conformity with the source audio signal and a playback corrected error by adapting the response of the secondary path estimate filter to minimize the playback corrected error; wherein the playback corrected error is based on a difference between the error microphone signal and the secondary path estimate.

6. A method for canceling ambient audio sounds in the proximity of a transducer of a personal audio device, the method comprising:
receiving a reference microphone signal indicative of ambient audio sounds;
receiving an error microphone signal indicative of the output of the transducer and the ambient audio sounds at the transducer;
generating a feedforward anti-noise signal component from a result of the measuring with the reference microphone countering the effects of ambient audio sounds at an acoustic output of the transducer by filtering an output of the reference microphone;
adaptively generating a feedback anti-noise signal component, from a result of the measuring with the error microphone, for countering the effects of ambient audio sounds at the acoustic output of the transducer by adapting a response of a feedback adaptive filter that filters a synthesized reference feedback to minimize the ambient audio sounds in the error microphone signal, wherein the synthesized reference feedback is based on a difference between the error microphone signal and the feedback anti-noise signal component; and
combining the anti-noise signal with a source audio signal to generate an audio signal provided to the transducer.

7. The method of claim 6, further comprising generating the feedforward anti-noise signal component from a result of the measuring with the reference microphone countering the effects of ambient audio sounds at an acoustic output of the transducer by adapting a response of an adaptive filter that filters an output of the reference microphone to minimize the ambient audio sounds in the error microphone signal.

8. The method of claim 6, further comprising generating a secondary path estimate from the source audio signal by filtering the source audio signal with a secondary path estimate filter for modeling an electro-acoustic path of the source audio signal through the transducer.

9. The method of claim 8, further comprising applying a response of the secondary path estimate filter to the feedback anti-noise signal component wherein the synthesized reference feedback is based on a difference between the error microphone signal and the feedback anti-noise signal component as filtered by the response of the secondary path estimate filter to the feedback anti-noise signal component.

10. The method of claim 8, further comprising generating the secondary path estimate by adapting a response of an adaptive filter that filters the synthesized reference feedback signal to minimize the ambient audio sounds in the error microphone signal to minimize a playback corrected error, wherein the playback corrected error is based on a difference between the error microphone signal and the secondary path estimate.

11. An integrated circuit for implementing at least a portion of a personal audio device, comprising:
an output for providing a signal to a transducer including both source audio for playback to a listener and an anti-noise signal for countering the effect of ambient audio sounds in an acoustic output of the transducer;
a reference microphone input for receiving a reference microphone signal indicative of the ambient audio sounds;
an error microphone input for receiving an error microphone signal indicative of the output of the transducer and the ambient audio sounds at the transducer; and
a processing circuit that implements:
a feedforward filter having a response that generates a feedforward anti-noise signal component from the reference microphone signal;
a feedback adaptive filter having a response that generates a feedback anti-noise signal component from a synthesized reference feedback, the synthesized reference feedback based on a difference between the error microphone signal and the feedback anti-noise signal component, and wherein the anti-noise signal comprises the feedforward anti-noise signal component and the feedback anti-noise signal component; and
a feedback coefficient control block that shapes the response of the feedback adaptive filter in conformity with the error microphone signal and the synthesized reference feedback by adapting the response of the feedback adaptive filter to minimize the ambient audio sounds in the error microphone signal.

12. The integrated circuit of claim 11, wherein the feedforward filter is an adaptive filter and the processing circuit further implements a feedforward coefficient control block that shapes the response of the feedforward filter in conformity with the error microphone signal and the reference microphone signal by adapting the response of the feedforward filter to minimize the ambient audio sounds in the error microphone signal.

13. The integrated circuit of claim 11, wherein the processing circuit further implements a secondary path estimate filter configured to model an electro-acoustic path of the source audio signal and have a response that generates the secondary path estimate from the source audio signal.

14. The integrated circuit of claim 13, wherein the synthesized reference feedback is based on a difference between the error microphone signal and a signal generated by applying the response of the secondary path estimate filter to the feedback anti-noise signal component.

15. The integrated circuit of claim 13, wherein the secondary path estimate filter is adaptive and the processing circuit further implements a secondary path estimate coefficient control block that shapes the response of the secondary path estimate filter in conformity with the source audio signal and a playback corrected error by adapting the response of the secondary path estimate filter to minimize the playback corrected error; wherein the playback corrected error is based on a difference between the error microphone signal and the secondary path estimate.
